(19) United States
(12) Patent Application Publication
(10) Pub. No.: US 2017/0229223 A1
(43) Pub. Date: Aug. 10, 2017

(54) MULTILAYER COIL COMPONENT

(71) Applicant: MURATA MANUFACTURING CO., LTD., Kyoto-fu (JP)

(72) Inventor: Yoshiko OKADA, Nagaokakyo-shi (JP)

(73) Assignee: MURATA MANUFACTURING CO., LTD., Kyoto-fu (JP)

(21) Appl. No.: 15/494,965

(22) Filed: Apr. 24, 2017

Related U.S. Application Data
(63) Continuation of application No. PCT/JP2015/081076, filed on Nov. 4, 2015.

(30) Foreign Application Priority Data
Nov. 6, 2014 (JP) 2014-226305

(51) Int. Cl. H01F 1/34; C04B 35/26; C04B 35/626; H01F 27/29; C04B 35/634; C04B 35/638; H01F 27/245; H01F 27/28; C04B 35/453; C04B 35/64

(52) U.S. Cl. CPC H01F 1/34; C04B 35/453; C04B 35/265; C04B 35/6261; C04B 35/64; C04B 35/6262; C04B 35/6342; C04B 35/638; H01F 27/245; H01F 27/2804; H01F 27/292; C04B 2235/3282; C04B 2235/3284; C04B 2235/3239; C04B 2235/3268; C04B 2235/3274; C04B 2235/3279; C04B 2235/6025; C04B 2235/612; C04B 2235/6567; C04B 2235/96; H01F 2027/2809

(57) ABSTRACT

A multilayer coil component including a magnetic part formed of a ferrite material, a non-magnetic part formed of a non-magnetic ferrite material, and a coiled conductive part embedded in the magnetic part and the non-magnetic part. The non-magnetic part has an Fe content of 36.0 to 48.5 mol % in terms of Fe₂O₃, a Zn content of 46.0 to 57.5 mol % in terms of ZnO, a V content of 0.5 to 5.0 mol % in terms of V₂O₅, a Mn content of 0 to 7.5 mol % in terms of Mn₂O₃, and a Cu content of 0 to 5.0 mol % in terms of CuO with respect to the sum of the Fe content in terms of Fe₂O₃, the Zn content in terms of ZnO, the V content in terms of V₂O₅, and if present, the Cu content in terms of CuO, and the Mn content in terms of Mn₂O₃.

### CROSS REFERENCE TO RELATED APPLICATIONS

This application claims benefit of priority to Japanese Patent Application 2014-226305 filed Nov. 6, 2014, and to International Patent Application No. PCT/JP2015/081076 filed Nov. 4, 2015, the entire content of which is incorporated herein by reference.

### TECHNICAL FIELD

The present disclosure relates to multilayer coil components and, more particularly, to a multilayer coil component including a non-magnetic layer.

### BACKGROUND

When copper is used as an inner conductor of a multilayer coil component, a copper conductor and a ferrite material (magnetic material) need to be fired simultaneously in a reducing atmosphere in which copper is not oxidized. Firing in such a condition causes, for example, a problem in that Fe³⁺ in the ferrite material is reduced to Fe²⁺, which lowers the specific resistance of the multilayer coil component. Therefore, a conductor containing silver as a main component has been commonly used. However, it is preferred to use a conductor containing copper as a main component because of low resistance, a lower cost than silver, and low possibility of electrochemical migration.

International Publication No. WO 2014/050867 discloses a multilayer coil component including a coiled conductive part containing copper as a main component and a magnetic part having a Cu content of 5 mol % or less in terms of CuO and having an Fe content of 25 to 47 mol % in terms of Fe₂O₃ and a Mn content of 1 mol % or more and less than 7.5 mol % in terms of Mn₂O₃ or having an Fe content of 35 to 45 mol % in terms of Fe₂O₃ and a Mn content of 7.5 to 10 mol % in terms of Mn₂O₃. According to the ferrite material containing these components, oxidation of Cu or reduction of Fe₂O₃ is supposed to be prevented or reduced even when the ferrite material is fired simultaneously with a Cu-based material.

Multilayer coil components are compact and lightweight. However, multilayer coil components commonly have a problem associated with lower rated current than wire wound coil components because the flow of large direct current causes a magnetic body to undergo magnetic saturation and thus reduces inductance. Therefore, there is a need to increase the saturation magnetic flux density of multilayer coil components, in other words, to improve the DC superposition characteristics of multilayer coil components (to obtain stable inductance over a wide range of direct current).

International Publication No. WO 2014/050867, the DC superposition characteristics are improved by forming a non-magnetic layer to provide an open magnetic path in an aspect of the multilayer coil component. This non-magnetic layer is formed of a Zn—Cu-based ferrite material obtained by replacing, with Zn, all of Ni in a Ni—Cu—Zn-based ferrite material, which is used for a magnetic layer.

### SUMMARY

### Technical Problem

Studies carried out by the inventors of the present disclosure reveal that a non-magnetic ferrite material having a high Zn content has low specific resistance and provides a multilayer coil component with a low Q value when the non-magnetic ferrite material has been fired in a reducing atmosphere.

The studies further reveal that, when the oxygen partial pressure during firing shifts to a value lower than a set value to create a reducing atmosphere, there are problems in that the multilayer coil component has lower specific resistance, and plating grows to a non-magnetic part when applying plating to an outer electrode. For example, when a large firing furnace is used in scaled-up processes, it is difficult to make the atmosphere in the firing furnace uniform, which may cause variations in oxygen partial pressure in the firing furnace. In this case, a multilayer coil component having low specific resistance is accordingly obtained at a location where the oxygen partial pressure is lower than a set value.

An object of the present disclosure is to provide a multilayer coil component having high specific resistance even after having been fired at a low oxygen partial pressure.

### Solution to Problem

As a result of intensive studies to solve the above-mentioned problems, the inventors of the present disclosure have found that the specific resistance can be improved by adding a predetermined amount of vanadium to a non-magnetic part and adjusting the amounts of other components, such as iron, zinc, manganese, and copper, completing the present disclosure.

According to one aspect of the present disclosure, a multilayer coil component includes a multilayer body including a magnetic part, a non-magnetic part, and a coil conductor, and an outer electrode that is formed on an outer surface of the multilayer body and is electrically coupled to the coil conductor.

The non-magnetic part has

an Fe content of 36.0 to 48.5 mol % in terms of Fe₂O₃,

a Zn content of 46.0 to 57.5 mol % in terms of ZnO,

a V content of 0.5 to 5.0 mol % in terms of V₂O₅,

a Mn content of 0 to 7.5 mol % in terms of Mn₂O₃, and

a Cu content of 0 to 5.0 mol % in terms of CuO

with respect to the sum of the Fe content in terms of Fe₂O₃, the Zn content in terms of ZnO, the V content in terms of V₂O₅, and if present, the Cu content in terms of CuO, and the Mn content in terms of Mn₂O₃.

### Advantageous Effects of Disclosure

According to the present disclosure, a multilayer coil component having high specific resistance even after having been fired at a low oxygen partial pressure is provided when a non-magnetic part has an Fe content of 36.0 to 48.5 mol % in terms of Fe₂O₃, a Zn content of 46.0 to 57.5 mol % in terms of ZnO, a Mn content of 0 to 7.5 mol % in terms of Mn₂O₃, and a Cu content of 0 to 5.0 mol % in terms of CuO, and a V content of 0.5 to 5.0 mol % in terms of V₂O₅.

### BRIEF DESCRIPTION OF THE DRAWINGS

FIG. 1 is a schematic perspective view of a multilayer coil component according to an embodiment of the present disclosure.

FIG. 2 is a schematic sectional view of the multilayer coil component according to the embodiment of FIG. 1 along line 2-2 in FIG. 1.

FIG. 3 is a schematic sectional view of the multilayer coil component according to the embodiment of FIG. 1 perpendicular to line 2-2 in FIG. 1. The conductive part is not illustrated.

FIG. 4 illustrates the ranges of the Fe content (in terms of Fe₂O₃) and the Mn content (in terms of Mn₂O₃) in the magnetic ferrite material.

### DETAILED DESCRIPTION

A multilayer coil component of the present disclosure and a method for producing the multilayer coil component will be described below in detail with reference to the drawings. It should be understood that the structure, the shape, the number of coiling, the configuration, or the like of the multilayer coil component of the present disclosure are not limited to those in the examples illustrated in the figures.

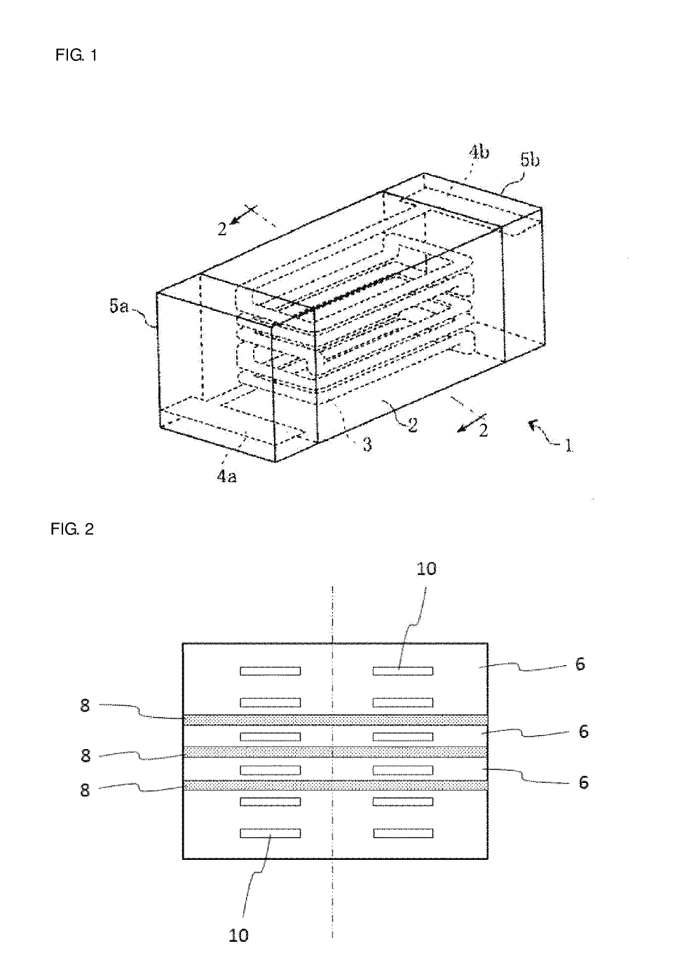

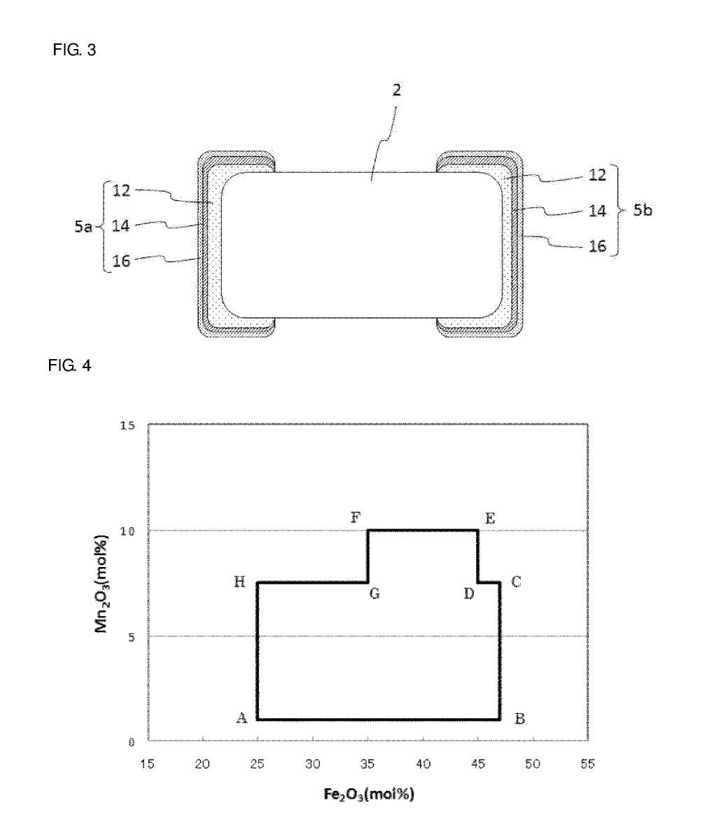

As illustrated in FIGS. 1 to 3, a multilayer coil component 1 according to this embodiment generally has a multilayer body 2 and a coiled conductive part 3 embedded in the multilayer body. Outer electrodes 5a and 5b cover the peripheral end surfaces of the multilayer body 2. Extended parts 4a and 4b located at both ends of the conductive part 3 are respectively connected to the outer electrodes 5a and 5b. As illustrated in FIG. 2, the multilayer body 2 is formed by stacking magnetic layers 6 and non-magnetic layers 8. In the conductive part 3, a plurality of conductive pattern layers 10 in the magnetic layers 6 and the non-magnetic layers 8 are connected to each other in a coiled manner through via-holes that penetrate through the magnetic layers 6 and the non-magnetic layers 8. As illustrated in FIG. 3, the outer electrodes 5a and 5b each include a metal layer 12, and a Ni layer 14 and a Sn layer 16. The metal layer 12 is coated with the Ni layer 14 and the Sn layer 16.

The magnetic layer 6 is formed of a sintered ferrite that contains Fe, Zn, and Ni and may further contain Mn, Cu, and/or V as desired.

The non-magnetic layer 8 is formed of a sintered ferrite that contains Fe, Mn, and V and may further contain Zn and/or Cu as desired.

The conductive part 3 is formed of a conductor containing a conductive metal, preferably formed of a conductor containing copper or silver as a main component, and more preferably formed of a conductor containing copper as a main component. The main component in the conductor refers to a component present in the largest amount in the conductor. The main component may be, for example, a component present in an amount of 50% by mass or more, preferably 80% by mass or more, more preferably 90% by mass or more, for example, 95% by mass or more, 98% by mass or more, or 99% by mass or more with respect to the entire conductor. In a preferred embodiment, the conductor is composed substantially of copper or silver, and preferably composed substantially of copper.

The metal layers 12 of the outer electrodes 5a and 5b are formed of any conductive metal, but are normally formed of a conductor containing copper or silver as a main component and preferably formed of a conductor containing copper as a main component. The Ni layer 14 has a function of protecting the outer electrode from solder. The Sn layer 16 has a function of improving soldering. In the present disclosure, the Ni layer 14 and the Sn layer 16 are optional and not necessarily present.

The multilayer coil component 1 according to this embodiment is produced in the following manner.

First, a magnetic ferrite material is prepared. The composition of the magnetic ferrite material is not limited. The magnetic ferrite material preferably contains Fe, Zn, and Ni and may further contain Mn, Cu, and/or V as desired.

In an embodiment, the magnetic ferrite material contains Fe, Mn, Zn, Ni, and Cu as main components. The magnetic ferrite material may be normally prepared by mixing Fe₂O₃, Mn₂O₃, ZnO, NiO, and CuO powders, which are raw materials of the main components, at a desired ratio, and calcining the mixture. The method for preparing the magnetic ferrite material is not limited to this method.

In this magnetic ferrite material, the Fe content (in terms of Fe₂O₃) is 25 mol % or more and 47 mol % or less and the Mn content (in terms of Mn₂O₃) is 1 mol % or more and less than 7.5 mol %, or the Fe content (in terms of Fe₂O₃) is 35 mol % or more and 45 mol % or less and the Mn content (in terms of Mn₂O₃) is 7.5 mol % or more and 10 mol % or less. That is, the composition of the magnetic ferrite material is within the range of the area Z illustrated in FIG. 4. FIG. 4 illustrates a graph where the x-axis represents the Fe content (in terms of Fe₂O₃) and the y-axis represents the Mn content (in terms of Mn₂O₃). In the figure, points (x, y) are A (25, 1), B (47, 1), C (47, 7.5), D (45, 7.5), E (45, 10), F (35, 10), G (35, 7.5), and H (25, 7.5). In this way, the magnetic ferrite material contains Fe₂O₃ and Mn₂O₃ together, where a combination of the Fe content (in terms of Fe₂O₃) and the Mn content (in terms of Mn₂O₃) is within the above-mentioned range. This can effectively avoid the reduction of Fe³⁺ to Fe²⁺ in sintering the magnetic ferrite material and can prevent or reduce a decrease in the specific resistance of the magnetic layer due to the reduction of Fe even when the magnetic ferrite material has been fired in a low-oxygen atmosphere, for example, at an oxygen partial pressure equal to or less than the Cu—Cu₂O equilibrium oxygen partial pressure (in a reducing atmosphere).

The Zn content (in terms of ZnO) in the magnetic ferrite material is preferably 6 to 33 mol % (based on the total main components). A Zn content (in terms of ZnO) of 6 mol % or more results in high magnetic permeability and large inductance. A Zn content (in terms of ZnO) of 33 mol % or less allows the magnetic ferrite material to have a high Curie point (e.g., 130° C. or higher) and ensures a high coil operating temperature.

The Cu content (in terms of CuO) in the magnetic ferrite material is preferably 5 mol % or less (based on the total main components). A Cu content (in terms of CuO) of 5 mol % or less allows the magnetic layer 6 to have high specific resistance. Copper in the magnetic ferrite material is an optional component, and the Cu content may be zero. The Cu content (in terms of CuO) may be 5 mol % or less, and preferably 0.2 mol % or more to obtain a sufficient degree of sintering.

The Ni content (in terms of NiO) in the magnetic ferrite material is not limited, and the Ni content may be the remainder after deduction of Fe, Mn, Zn, and Cu, which are other main components described above.

In another embodiment, the magnetic ferrite material contains Fe, Zn, Ni, and V, and may further contain Mn and/or Cu as desired. The magnetic ferrite material is normally prepared by mixing Fe₂O₃, ZnO, NiO, V₂O₅, Mn₂O₃, and CuO powders, which are raw materials of the main components, at a desired ratio, and calcining the mixture. The method for preparing the magnetic ferrite material is not limited to this method.

The Fe content (in terms of Fe₂O₃) in the magnetic ferrite material is preferably 36.0 to 48.5 mol % (based on the total main components). An Fe content (in terms of Fe₂O₃) of 48.5 mol % or less allows the reduction of Fe³⁺ to Fe²⁺ to be suppressed and causes a decrease in specific resistance to be prevented or reduced. An Fe content (in terms of Fe₂O₃) of less than 36.0 mol % rather causes the specific resistance to be reduced, which results in a failure to ensure electrical insulation. The Fe content is thus preferably 36.0 mol % or more.

The Zn content (in terms of ZnO) in the magnetic ferrite material is preferably 6.0 to 45.0 mol % (based on the total main components). A Zn content (in terms of ZnO) of 6.0 mol % or more results in high magnetic permeability and large inductance. A Zn content (in terms of ZnO) of 45.0 mol % or less can avoid a decrease in Curie point and avoid a decrease in the operating temperature of the multilayer coil component.

The V content (in terms of V₂O₅) in the magnetic ferrite material is preferably 0.5 to 5.0 mol % (based on the total main components). Firing the multilayer body when the V content (in terms of V₂O₅) is 0.5 to 5.0 mol % can improve specific resistance and can further reduce variations in specific resistance among multilayer coil components.

The magnetic ferrite material may further contain Cu. The Cu content (in terms of CuO) in the magnetic ferrite material is preferably 0 to 5.0 mol % (based on the total main components). Copper is an optional component, and the Cu content may be zero. In an embodiment, the Cu content (in terms of CuO) in the magnetic ferrite material is 0.1 to 5.0 mol %. Firing the multilayer body in which the magnetic ferrite material contains Cu can improve DC superposition characteristics and can reduce a change in magnetic properties obtained when the multilayer body is subjected to thermal shock testing.

The magnetic ferrite material may further contain Mn. The Mn content (in terms of Mn₂O₃) in the magnetic ferrite material is preferably 0 to 7.5 mol % (based on the total main components). Manganese is an optional component, and the Mn and Cu contents may be zero. In an embodiment, the Mn content (in terms of Mn₂O₃) in the magnetic ferrite material is 0.1 to 7.5 mol %. The addition of Mn to the magnetic ferrite material allows the magnetic body to have low magnetic coercive force and thus increases magnetic flux density, which improves magnetic permeability. The addition of Mn also causes the reduction of Mn more preferentially than the reduction of Fe, which can avoid a decrease in specific resistance due to the reduction of Fe.

The Ni content (in terms of NiO) in the magnetic ferrite material is not limited, and the Ni content may be the remainder after deduction of Fe, Zn, V, Cu, and Mn, which are other main components described above.

In the present disclosure, the magnetic ferrite material may further contain additives. Examples of the additives in the magnetic ferrite material include, but are not limited to, Bi. The Bi content (addition amount) in terms of Bi₂O₃ is preferably 0.1 to 1 part by weight with respect to 100 parts by weight of the total main components (Fe (in terms of Fe₂O₃), Zn (in terms of ZnO), V (in terms of V₂O₅), Cu (in terms of CuO), Mn (in terms of Mn₂O₃), and Ni (in terms of NiO)). A Bi content (in terms of Bi₂O₃) of 0.1 to 1 part by weight causes low-temperature firing to be promoted and allows abnormal grain growth to be prevented or reduced. An excessive Bi content (in terms of Bi₂O₃) is not preferred because such a Bi content tends to cause abnormal grain growth. The specific resistance is low at abnormal grain growth sites, and a plating is attached to the abnormal grain growth sites when plating is performed to form the outer electrodes.

With respect to the magnetic part before and after sintering, for example, part of CuO and Fe₂O₃, which form the magnetic ferrite material before sintering, may be respectively converted into Cu₂O and Fe₃O₄ by firing. However, the amounts of the main components in the magnetic part after sintering, such as the Cu content in terms of CuO and the Fe content in terms of Fe₂O₃, are respectively considered substantially equal to the amounts of the main components in the magnetic ferrite material before sintering, such as the CuO content and the Fe₂O₃ content.

A magnetic sheet is prepared by using the magnetic ferrite material. For example, a magnetic sheet may be obtained as follows: mixing/kneading the magnetic ferrite material with an organic vehicle containing a binder resin and an organic solvent; and forming the mixture into a sheet. The method for preparing the magnetic sheet is not limited to this method. Separately, a non-magnetic ferrite material is prepared. The non-magnetic ferrite material contains Fe, Zn, and V, and may further contain Mn and/or Cu as desired. The non-magnetic ferrite material is normally prepared by mixing Fe₂O₃, ZnO, V₂O₅, Mn₂O₃, and CuO powders, which are raw materials of the main components, at a desired ratio, and calcining the mixture. The method for preparing the non-magnetic ferrite material is not limited to this method.

The Fe content (in terms of Fe₂O₃) in the non-magnetic ferrite material is 36.0 to 48.5 mol % (based on the total main components). An Fe content (in terms of Fe₂O₃) of 48.5 mol % or less allows the reduction of Fe³⁺ to Fe²⁺ to be suppressed and causes a decrease in specific resistance to be prevented or reduced. An Fe content (in terms of Fe₂O₃) of less than 36.0 mol % rather causes the specific resistance to be reduced, which results in a failure to ensure electrical insulation. The Fe content is thus preferably 36.0 mol % or more.

The V content (in terms of V₂O₅) in the non-magnetic ferrite material is 0.5 to 5.0 mol % (based on the total main components). The V content (in terms of V₂O₅) is preferably 0.5 mol % or more and less than 4.0 mol %, more preferably 0.5 to 3.5 mol %, and still more preferably 0.5 to 3.0 mol %. Firing the multilayer body in which the V content (in terms of V₂O₅) in the non-magnetic ferrite material is 0.5 to 5.0 mol % can improve specific resistance and can further reduce variations in specific resistance among multilayer coil components.

The Zn content (in terms of ZnO) in the non-magnetic ferrite material is 46.0 to 57.5 mol % (based on the total main components).

In the present disclosure, the non-magnetic ferrite material may further contain Cu. The Cu content (in terms of CuO) in the ferrite material is 0 to 5.0 mol % (based on the total main components). Copper is an optional component, and the Cu content may be zero. In an embodiment, the Cu content (in terms of CuO) in the ferrite material is 0.1 to 5.0 mol %. Firing the multilayer body in which the ferrite material contains Cu provides a high degree of sintering. A Cu content (in terms of CuO) of 5 mol % or less results in reduced production of a different phase (CuO phase) and suppresses a decrease in the specific resistance of the non-magnetic part.

In the present disclosure, the non-magnetic ferrite material may further contain Mn. The Mn content (in terms of Mn₂O₃) in the ferrite material is 0 to 7.5 mol % (based on the total main components). Manganese is an optional component, and the Mn content may be zero. In an embodiment, the Mn content (in terms of Mn₂O₃) in the ferrite material is 0.1 to 7.5 mol %. Since Mn is more preferentially reduced than Fe when Mn is added, a decrease in specific resistance due to the reduction of Fe can be avoided.

With regard to the non-magnetic part before and after sintering, for example, part of CuO and Fe₂O₃, which form the non-magnetic ferrite material before sintering, may be respectively converted into Cu₂O and Fe₃O₄ by firing. However, the amounts of the main components in the non-magnetic part after sintering, such as the Cu content in terms of CuO and the Fe content in terms of Fe₂O₃, are respectively considered substantially equal to the amounts of the main components in the non-magnetic ferrite material before sintering, such as the CuO content and the Fe₂O₃ content.

A non-magnetic sheet is prepared by using the non-magnetic ferrite material. For example, the non-magnetic sheet may be obtained as follows: mixing/kneading the non-magnetic ferrite material with an organic vehicle containing a binder resin and an organic solvent; and forming the mixture into a sheet. The method for preparing the non-magnetic sheet is not limited to this method.

Separately, a conductive paste is prepared. The conductive paste is preferably, but not necessarily, for example, a paste containing silver or copper and more preferably a paste containing copper. For example, a commercially available ordinary copper paste containing copper in a powder form may be used, but the conductive paste is not limited to this paste.

Next, a multilayer body is obtained by stacking the magnetic sheets and the non-magnetic sheets with conductive paste layers each interposed therebetween such that the conductive paste layers are connected to each other in a coiled manner through via-holes that penetrate through the magnetic sheets and the non-magnetic sheets.

A method for forming the multilayer body is not limited, and the multilayer body may be formed by using, for example, a sheet lamination method or a printing lamination method. In the sheet lamination method, a multilayer body can be obtained as follows: appropriately making via-holes in the magnetic sheets or the non-magnetic sheets; applying a conductive paste in a predetermined pattern to form conductive paste layers (while filling the via-holes with the conductive paste when the via-holes are present); stacking and pressure-bonding the magnetic sheets and the non-magnetic sheets on each of which the conductive paste layer has been formed appropriately; and cutting into a predetermined size. In the printing lamination method, a multilayer body can be obtained as follows: applying a magnetic ferrite paste, a non-magnetic ferrite paste, and a conductive paste in a predetermined order to a substrate, such as PET (polyethylene terephthalate) film, by using the magnetic ferrite material and the non-magnetic ferrite as pastes; appropriately repeating formation of the magnetic paste layer, the non-magnetic paste layer, and the conductive paste layer; and finally cutting into a predetermined size. This multilayer body may be prepared by once producing a matrix of plural multilayer bodies and then separating them into individual pieces (element isolation) with a dicing machine or the like or may be prepared individually in advance.

Next, the magnetic sheets and the conductive paste layers are fired by subjecting the unfired multilayer body obtained as described above to a heat treatment at a predetermined oxygen partial pressure, which provides magnetic layers 6, non-magnetic layers 8, and conductive layers 10. In the multilayer body 2 thus obtained, the magnetic layers 6 form magnetic parts, the non-magnetic layers 8 form non-magnetic parts, and the conductive layers form the conductive part 3.

The oxygen partial pressure during such firing is not limited. When the conductive part contains Cu as a main component, the oxygen partial pressure is preferably the Cu—Cu₂O equilibrium oxygen partial pressure or less (reducing atmosphere), and more preferably the Cu—Cu₂O equilibrium oxygen partial pressure. The heat treatment of the unfired multilayer body at such an oxygen partial pressure can avoid oxidation of Cu in the conductive part and also allows the unfired multilayer body to be sintered at a temperature lower than the temperature in the case of a heat treatment in the air. The firing temperature may be, for example, 950° C. to 1100° C. The present disclosure is not restricted by any theory. When firing is performed in a low oxygen concentration atmosphere, oxygen defects are formed in the crystal structure, mutual diffusion of Fe, Zn, V, Cu, Mn, and Ni through these oxygen defects is promoted, which improves low-temperature sintering properties.

Next, outer electrodes 5a and 5b are formed on the end surfaces of the multilayer body 2 obtained as described above. The outer electrodes 5a and 5b may be formed by, for example, applying a paste containing a copper or silver powder, glass, and the like to a predetermined area, and subjecting the resulting structure to a heat treatment, for example, at 700° C. to 850° C. to bake copper or silver in an appropriate atmosphere, for example, in an atmosphere in which copper is not oxidized, when the conductive part contains Cu as a main component.

The multilayer coil component 1 according to this embodiment is produced as described above.

In the multilayer coil component of the present disclosure, the non-magnetic part contains vanadium and thus has high specific resistance and is less affected by variations in oxygen partial pressure in mass production, which results in a few variations in specific resistance, compared with a related non-magnetic layer free of vanadium. The present disclosure is not restricted by any theory, but the reasons why adding vanadium to the non-magnetic part improves specific resistance and reduces variations in specific resistance may be considered as described below. A decrease in specific resistance may result from the reduction of Fe³⁺ to Fe²⁺ and subsequent hopping conduction between B sites. When V (V₂O₅) is present here, V⁵⁺ is reduced to V⁴⁺ or V³⁺, and the presence of this V at B sites suppresses hopping conduction and thus improves specific resistance.

The specific resistance (log ρ) of the non-magnetic part in the multilayer coil component of the present disclosure may be preferably 4.5 ωcm or more, more preferably 4.8 ωcm or more, and still more preferably 5.0 ωcm or more.

In a preferred embodiment, the conductive part in the multilayer coil component of the present disclosure is formed of a conductor containing copper. The magnetic parts, the non-magnetic parts, and the conductive part in the multilayer coil component are simultaneously fired preferably at the Cu—Cu₂O equilibrium oxygen partial pressure or less (in a reducing atmosphere). Firing at the Cu—Cu₂O equilibrium oxygen partial pressure or less prevents oxidation of copper in the conductive part. When the non-magnetic part has a particular composition as described above, even simultaneous firing in a reducing atmosphere allows the non-magnetic part to maintain high specific resistance.

Although an embodiment of the present disclosure is described above, the present disclosure is not limited to this embodiment, and various modifications can be made.

### EXAMPLES

### Example 1: Evaluation of Non-Magnetic Layer

To produce non-magnetic layers, Fe₂O₃, ZnO, V₂O₅, Mn₂O₃, and CuO powders were weighed so as to obtain the compositions with the ratios indicated by sample numbers 1 to 29 in Table 1. Sample numbers 2 to 7, 10 to 16, 19 to 24, and 26 to 28 correspond to Examples of the present disclosure, and sample numbers 1, 8, 9, 17, 18, 25, and 29 (with symbol “*” in Table) correspond to Comparative Examples.

TABLE 1

| | Composition of Non-Magnetic | | | | |
|---|---|---|---|---|---|
| | Ferrite (mol %) | | | | |
| Sample No. | Fe₂O₃ | Mn₂O₃ | V₂O₅ | ZnO | CuO |
| *1 | 46.5 | 2.5 | 0.0 | 50.0 | 1.0 |
| 2 | 46.0 | 2.5 | 0.5 | 50.0 | 1.0 |
| 3 | 45.5 | 2.5 | 1.0 | 50.0 | 1.0 |
| 4 | 44.5 | 2.5 | 2.0 | 50.0 | 1.0 |
| 5 | 43.5 | 2.5 | 3.0 | 50.0 | 1.0 |
| 6 | 42.5 | 2.5 | 4.0 | 50.0 | 1.0 |
| 7 | 41.5 | 2.5 | 5.0 | 50.0 | 1.0 |
| *8 | 39.5 | 2.5 | 7.0 | 50.0 | 1.0 |
| *9 | 49.0 | 0.0 | 0.0 | 50.0 | 1.0 |
| 10 | 48.5 | 0.0 | 0.5 | 50.0 | 1.0 |
| 11 | 48.0 | 0.0 | 1.0 | 50.0 | 1.0 |
| 12 | 47.0 | 0.0 | 2.0 | 50.0 | 1.0 |
| 13 | 46.9 | 0.1 | 2.0 | 50.0 | 1.0 |
| 14 | 46.0 | 1.0 | 2.0 | 50.0 | 1.0 |
| 15 | 42.0 | 5.0 | 2.0 | 50.0 | 1.0 |
| 16 | 39.5 | 7.5 | 2.0 | 50.0 | 1.0 |
| *17 | 37.0 | 10.0 | 2.0 | 50.0 | 1.0 |
| *18 | 27.0 | 20.0 | 2.0 | 50.0 | 1.0 |
| 19 | 44.5 | 2.5 | 2.0 | 51.0 | 0.0 |
| 20 | 44.5 | 2.5 | 2.0 | 50.9 | 0.1 |
| 21 | 44.5 | 2.5 | 2.0 | 49.0 | 2.0 |
| 22 | 44.5 | 2.5 | 2.0 | 48.0 | 3.0 |
| 23 | 44.5 | 2.5 | 2.0 | 47.0 | 4.0 |
| 24 | 44.5 | 2.5 | 2.0 | 46.0 | 5.0 |
| *25 | 44.5 | 2.5 | 2.0 | 41.0 | 10.0 |
| 26 | 42.0 | 2.5 | 2.0 | 52.5 | 1.0 |
| 27 | 39.0 | 2.2 | 2.7 | 55.0 | 1.1 |
| 28 | 36.0 | 2.1 | 3.3 | 57.5 | 1.1 |
| *29 | 33.0 | 1.9 | 3.9 | 60.0 | 1.2 |

Next, the weighed materials for each of sample numbers 1 to 29 were placed in a pot mill made of vinyl chloride together with pure water and PSZ (partial stabilized zirconia) balls, followed by sufficient wet grinding and mixing. The ground material was dried by evaporation and then calcined at a temperature of 750° C. for 2 hours. The calcined powder thus obtained was placed in the pot mill made of vinyl chloride again together with ethanol (organic solvent) and PSZ balls, followed by sufficient grinding and mixing. A polyvinyl butyral-based binder (organic binder) was further added, and the mixture was mixed well to obtain a ceramic slurry. Next, the obtained ceramic slurry was formed into a sheet having a thickness of 25 μm by a doctor blade method. The formed product thus obtained was punched out into a size of 50 mm in length and 50 mm in width to provide non-magnetic sheets made of a ferrite material.

Next, the non-magnetic sheets were stacked such that the thickness after firing was 0.5 mm, and were pressure-bonded at a pressure of 100 MPa and a temperature of 60° C. for 1 minute to produce a pressure-bonded block. The pressure-bonded block thus obtained was punched out with a dice into disk-shaped samples having a diameter of 10 mm and ring-shaped samples having an outer diameter of 20 mm and an inner diameter of 12 mm.

These samples were placed in a firing furnace and degreased well by heating to 400° C. in nitrogen. Next, the samples were fired at 1000° C. for 3 hours while the oxygen partial pressure was controlled at the Cu—Cu₂O equilibrium oxygen partial pressure by using a N₂—H₂-H₂O gas mixture.

To both sides of the disk-shaped sample thus obtained, a copper paste (copper paste for forming outer electrodes) containing a Cu powder, glass frit, varnish, and an organic solvent was applied and baked at 800° C. for 5 minutes in an atmosphere in which copper is not oxidized, forming electrodes.

A DC voltage of 50 V was applied across the electrodes, and the resistance after 1 minute was measured. Specific resistance log ρ (ω·cm) was obtained from this measured resistance and the sample size. The mean of 10 samples was calculated, and the results are shown in Table 2.

The ring-shaped sample was placed in a magnetic material test fixture (model: 16454 A-s) available from Agilent Technologies, Inc., and the initial magnetic permeability μ at 1 MHz was measured by using an impedance analyzer (model: E4991A) available from Agilent Technologies, Inc. The mean of 30 samples was calculated, and the results are shown in Table 2.

### Example 2: Evaluation of Multilayer Coil Component

To produce magnetic layers, Fe₂O₃, Mn₂O₃, ZnO, NiO, and CuO powders were provided and weighed so as to obtain the composition with 46.5 mol % of Fe₂O₃, 2.5 mol % of Mn₂O₃, 30.0 mol % of ZnO, 20.0 mol % of NiO, and 1.0 mol % of CuO. These weighed materials were placed in a pot mill made of vinyl chloride together with pure water and PSZ balls, followed by sufficient wet grinding and mixing, as in Example 1. The ground material was dried by evaporation and then calcined at a temperature of 750° C. for 2 hours. The calcined powder thus obtained was placed in the pot mill made of vinyl chloride again together with ethanol (organic solvent) and PSZ balls, followed by sufficient wet grinding and mixing. A polyvinyl butyral-based binder (organic binder) was further added, and the mixture was mixed well to obtain a ceramic slurry.

Next, the obtained ceramic slurry was formed into a sheet having a thickness of 25 μm by a doctor blade method. The formed sheet was punched out into a size of 50 mm in length and mm in width to provide magnetic sheets made of a ferrite material.

Next, via-holes were formed, by using a laser beam machine, at predetermined positions in the non-magnetic sheets of sample numbers 1 to 27 produced in Example 1 and the magnetic sheets produced as described above. Subsequently, a coil pattern was formed by applying a Cu paste containing a Cu powder, varnish, and an organic solvent to the surface of each magnetic sheet by screen printing, and filling the via-holes with the Cu paste.

The non-magnetic sheets of any one of sample numbers 1 to 29 and the magnetic sheets thus produced were stacked so as to obtain the arrangement (including three layers of any one of sample numbers 1 to 29) as illustrated in FIG. 2 and were pressure-bonded at a pressure of 100 MPa at a temperature of 60° C. for 1 minute to produce a pressure-bonded block. This pressure-bonded block was cut in a predetermined size to produce ceramic multilayer bodies.

Some of the ceramic multilayer bodies thus produced were placed in a firing furnace and degreased well by heating to 400° C. in nitrogen. Next, the ceramic multilayer bodies were fired at 1000° C. for 3 hours while the oxygen partial pressure was controlled at the Cu—Cu₂O equilibrium oxygen partial pressure by using a N₂—H₂-H₂O gas mixture. Separately, the other ceramic multilayer bodies were fired similarly at an oxygen partial pressure of 0.1 times the Cu—Cu₂O equilibrium oxygen partial pressure.

Next, the copper paste for forming outer electrodes used in Example 1 was applied to both sides of the fired ceramic multilayer body and dried. The copper paste was then baked at 800° C. for 5 minutes in an atmosphere in which copper is not oxidized. Furthermore, Ni plating and Sn plating were sequentially performed by electroplating to form outer electrodes having an electrode structure as illustrated in FIG. 3. In this way, the multilayer coil component (FIG. 1) in which the coil conductor was embedded in the magnetic parts was produced. The produced multilayer coil component was 2.1 mm in length, 1.0 mm in width, and 1.0 mm in thickness.

The distance between the position of the end of the outer electrode and the furthest position to which the plating elongated was measured by observing the sample surfaces (two LT surfaces defined by the longitudinal dimension (L) and the thickness dimension (T)) of samples (n=10 for each sample) each having any one of the non-magnetic layers of sample numbers 1 to 29 through an optical microscope. The measurement was performed at three locations at which the non-magnetic layer was formed, namely, at six locations on both sides for each sample (n=10), so that a total of 120 pieces of data was obtained from each sample. A sample was rated A when the length of plating elongation was 100 μm or less at all locations, while a sample was rated B (poor) when the length of plating elongation was more than 100 μm at least one location. This evaluation was performed for the samples that had been fired at the Cu—Cu₂O equilibrium oxygen partial pressure and the samples that had been fired at an oxygen partial pressure of 0.1 times the Cu—Cu₂O equilibrium oxygen partial pressure. The results are all shown in Table 2.

TABLE 2

| | | | Deposition of Plating | |
|---|---|---|---|---|
| | | | | Fired at |
| | | | | Oxygen Partial |
| | | | | Pressure |
| | | | | Of 0.1 Times |
| | | | Fired at | Cu—Cu₂O |
| | | | Cu—Cu₂O | Equilibrium |
| | Magnetic | Specific | Equilibrium | Oxygen |
| Sample | Permeability | Resistance | Oxygen Partial | Partial |
| No. | μ (—) | log ρ (Ωcm) | Pressure | Pressure |
| *1 | 1 | 3.7 | A | B |
| 2 | 1 | 4.8 | A | A |
| 3 | 1 | 5.4 | A | A |
| 4 | 1 | 5.2 | A | A |
| 5 | 1 | 4.8 | A | A |
| 6 | 1 | 4.6 | A | B |
| 7 | 1 | 4.5 | A | B |
| *8 | 1 | 3.9 | A | B |
| *9 | 1 | 3.4 | B | B |
| 10 | 1 | 4.7 | A | A |
| 11 | 1 | 5.5 | A | A |
| 12 | 1 | 5.6 | A | A |
| 13 | 1 | 5.7 | A | A |
| 14 | 1 | 5.5 | A | A |
| 15 | 1 | 5.8 | A | A |
| 16 | 1 | 5.6 | A | A |
| *17 | 12 | 5.6 | A | A |
| *18 | 25 | 5.7 | A | A |
| 19 | 1 | 5.3 | A | A |
| 20 | 1 | 5.4 | A | A |
| 21 | 1 | 5.2 | A | A |
| 22 | 1 | 5.4 | A | A |
| 23 | 1 | 5.5 | A | A |
| 24 | 1 | 5.3 | A | A |
| *25 | 1 | 3.8 | A | A |
| 26 | 1 | 5.6 | A | A |
| 27 | 1 | 5.0 | A | A |
| 28 | 1 | 4.7 | A | A |
| *29 | 1 | 3.5 | B | B |

As is apparent from the above description, the results in Example 1 indicate that the samples of sample numbers 2 to 7, 10 to 16, 19 to 24, and 26 to 28 within the scope of the present disclosure have a magnetic permeability of 1.0 and thus are non-magnetic. It is found that the non-magnetic layers within the scope of the present disclosure have a specific resistance log ρ as high as 4.5 or more even after having been fired at the Cu—Cu₂O equilibrium oxygen partial pressure. It is also found that the samples of sample numbers 1, 8, 9, 17, 18, 25, and 29, in which at least one component in the non-magnetic ferrite material is out of the scope of the present disclosure, have a small specific resistance (log ρ of less than 4) or have magnetism.

The results in Example 2 indicate that the samples including the non-magnetic ferrite material within the scope of the present disclosure do not undergo a defect caused by plating elongation even after the samples have been fired at the Cu—Cu₂O equilibrium oxygen partial pressure.

Furthermore, it is also found that, when the amount of V₂O₅ added is 0.5 mol % or more and less than 4.0 mol %, a defect caused by plating elongation does not occur even in the case of firing at an oxygen partial pressure of 0.1 times the Cu—Cu₂O equilibrium oxygen partial pressure. This indicates that the multilayer coil component can be stably produced even when the oxygen partial pressure changes to a value lower than a set value to create a low-oxygen atmosphere during firing.

### INDUSTRIAL APPLICABILITY

The multilayer coil component obtained in the present disclosure may be used, for example, in a wide range of applications of electronic devices.

1. A multilayer coil component comprising:
a magnetic part formed of a ferrite material;
a non-magnetic part formed of a non-magnetic ferrite material; and
a coiled conductive part embedded in the magnetic part and the non-magnetic part,
wherein the non-magnetic part has
an Fe content of 36.0 to 48.5 mol % in terms of Fe₂O₃,
a Zn content of 46.0 to 57.5 mol % in terms of ZnO,
a V content of 0.5 to 5.0 mol % in terms of V₂O₅,
a Mn content of 0 to 7.5 mol % in terms of Mn₂O₃, and
a Cu content of 0 to 5.0 mol % in terms of CuO
with respect to a sum of the Fe content in terms of Fe₂O₃, the Zn content in terms of ZnO, the V content in terms of V₂O₅, and if present, the Cu content in terms of CuO, and the Mn content in terms of Mn₂O₃.

2. The multilayer coil component according to claim 1, wherein the V content in terms of V₂O₅ is 0.5 to 3.5 mol %.

3. The multilayer coil component according to claim 1, wherein the Mn content in terms of Mn₂O₃ is 0.1 to 7.5 mol %.

4. The multilayer coil component according to claim 1, wherein the Cu content in terms of CuO is 0.1 to 5.0 mol %.

5. The multilayer coil component according to claim 1, wherein the conductive part is formed of a conductor containing copper.
